(19) United States
(12) Patent Application Publication
(10) Pub. No.: US 2004/0043788 A1
(43) Pub. Date: Mar. 4, 2004

(54) Management of parameters in a removable user identity module

(76) Inventor: Guarav Mittal, San Diego, CA (US)

Correspondence Address: Milan Patel, c/o Nokia Mobile Phones (Patent Dept.), Mail Stop 1-4-755, 6000 Connection Drive, Irving, TX, 75039, US

(21) Appl. No.: 10/233,189

(22) Filed: Aug. 28, 2002

(51) Int. Cl. H04M 3/00; H04Q 7/20; H04M 1/00; H04B 1/38

(52) U.S. Cl. 455/558; 455/418; 455/425

(57) ABSTRACT

A wireless communications network includes at least one mobile station and a device management server. Each mobile station has a plurality of operating parameters stored within a removable user identity module (R-UIM), with at least one of the parameters capable of being downloaded to the mobile station. The device management server is capable of controlling a message center to transmit a text message to the mobile station over the network such that the mobile station establishes a traffic channel connection between the mobile station and the device management server. The mobile station can also establish an identity with the device management server such that the device management server can download operating parameters to the mobile station via the traffic channel. In turn, the mobile station is capable of storing the operating parameters in the R-UIM. The device management server can then terminate the traffic channel connection.

### BACKGROUND OF THE INVENTION

The present invention relates to operating parameters of mobile stations and, more particularly, relates to management of operating parameters of mobile stations that are stored in removable user identity modules (R-UIM).

Over-the-air service provisioning (OTASP) for activation of mobile stations is well known, with established standards provided in Telecommunications Industry Association/Electronics Industries Association Interim Standard 683 (TIA/EIA/IS-683). Generally, OTASP allows a network service provider to activate new service without intervention of a third party, such as an authorized dealer. OTASP enables the service provider to activate a potential subscriber's (mobile user's) mobile station by downloading the required parameters, e.g., a phone number, to the mobile unit over the air. Since a qualified dealer or service agent is not required to initiate the procedure, service providers have the capability of marketing mobile phones through general merchandise-type retail stores, such as drug stores and discount department stores, rather than specialty electronics stores. Typically, OTASP can be initiated only by the user and requires connection to the service provider's customer service center for interaction with a customer service representative.

In addition to downloading the phone number, OTASP provides the ability to securely load an authentication key (“A-Key”) into the mobile station to allow validation and confirmation of the identity of the mobile unit to enhance security and reduce the potential for fraudulent use of the network service. Also, parameters such Number Assignment Modules (NAMs) can be downloaded into the memory of the mobile station from the base station. The NAMs specify particular parameters that control wireless network usage, such as preferred mode of operation (analog or digital), shared secret data (SSD), and roaming information such as a “Preferred Roaming List”.

Adding to the mobility of mobile communications, the parameters can be stored on a removable memory device known as a removable user identity module (R-UIM), along with other information, such as short (SMS) messages, the user's private phone book and other user-selectable information. Generally, the R-UIM is a smart card used in mobile communication devices such as mobile stations in the CDMA system. The CDMA system directs a user's incoming calls to the mobile station housing the user's RUIM. As such, the user can change mobile stations simply by moving the R-UIM from one mobile station to another. Operation of the R-UIM is described in more detail in Telecommunications Industry Association/Electronics Industries Association Interim Standard 820 (TIA/EIA/IS-820).

Subsequent to the initial programming of the mobile station, changes can be made to the parameters stored in the R-UIM by means of a process known as over-the-air parameter administration (OTAPA). For example, OTAPA can be used to change the area code of the phone number, or change the Preferred Roaming List parameters based upon new service areas and/or new roaming agreements with other network providers. In addition, it is often necessary to modify at least some of the parameters in the R-UIM when service providers offer new services to users. As the number of available services increases, the more difficult it becomes for service providers to easily modify parameters in the R-UIM. And while current techniques exist for downloading and modifying parameters in the R-UIM, such techniques have drawbacks in that they typically operate in a bandwidth limited signaling channel and do not provide for managing the parameters stored in the R-UIM.

### SUMMARY OF THE INVENTION

In light of the foregoing background, the present invention provides an improved system, mobile station and method capable of downloading at least one of a plurality of operating parameters to a mobile station that operates within a network. In this regard, the plurality of operating parameters are stored within a removable user identity module (R-UIM). The system, mobile station and method can download the parameters over a traffic channel that is less bandwidth limited than the signaling channel, thus freeing up network resources during the downloading of the parameters. Also, the system, mobile station and method can manage the parameters by including a device management tree in the mobile station that includes a node for the R-UIM such that the parameters within the R-UIM can be uniquely addressed based upon the node. Therefore, the system, mobile station and method of the present invention solve the problems identified by prior systems, mobile stations and downloading techniques and provide additional advantages.

According to one embodiment, a wireless communications network includes at least one mobile station and a device management server. Each mobile station has a plurality of operating parameters stored within a removable user identity module (RUIM), with at least one of the parameters capable of being downloaded to the mobile station. Each mobile station can include mobile equipment and the R-UIM. In this regard, the mobile equipment of each mobile station is capable of establishing a node for the R-UIM in a hierarchical device management tree of the respective mobile station. Thus, the mobile station is capable of storing the operating parameters in the R-UIM based upon the node for the R-UIM in the device management tree.

The device management server is capable of downloading parameters to the mobile station. In this regard, the device management server is capable of controlling a message center to transmit a text message to at least one mobile station over the network such that the mobile station establishes a traffic channel connection, such as an Internet Protocol (IP) connection, between the mobile station and the device management server in response to the text message. The mobile station is also capable of establishing an identity with the device management server. For example, the mobile station can establish the identity by transmitting a hash function to the device management server, where the hash function identifies the R-UIM and establishes authority for downloading the operating parameters. Upon identifying the mobile station to the device management server, the device management server can download operating parameters to the mobile station via the traffic channel. In turn, the mobile station is capable of storing the operating parameters in the R-UIM. Following downloading the parameters, the device management server is capable of terminating the traffic channel connection between the mobile station and the device management server.

The wireless communications network can more particularly include a cellular network and a data network. In this regard, each mobile station is included in both the cellular network and the data network, and the device management server is included within the data network. The device management server can therefore control the message center such that the message center transmits the text message to the mobile station over the cellular network. The mobile station can establish the identity with the device management server over the data network. And the device management server can download the operating parameters to the mobile station over the data network.

### BRIEF DESCRIPTION OF THE DRAWINGS

Having thus described the invention in general terms, reference will now be made to the accompanying drawings, which are not necessarily drawn to scale, and wherein:

FIG. 1A is a block diagram of a wireless communications system according to one embodiment of the present invention including a cellular network and a data network to which the mobile station is bidirectionally coupled through wireless RF links;

FIG. 1B is a block diagram of a mobile station according to one embodiment of the present invention;

FIG. 2 is a flow chart illustrating the steps in equipping a mobile station with a removable user identity module (R-UIM) according to one embodiment of the present invention; and

FIG. 3 is a flow chart illustrating the steps in over-the-air service provisioning (OTASP) according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is applicable to all mobile radio systems utilizing subscriber identity modules (SIMs), removable user identity modules (R-UIMs) or the like. The present invention is particularly advantaged when applied in the spread spectrum, code division multiple access (CDMA) system or in the modifications thereof. In the following, the preferred embodiment of the invention will be described as an application in a CDMA system, to which the invention, however, is not intended to be limited.

As described herein, the present invention applies to a mobile station, however, in general, the present invention applies to any terminal, such as any landline telephone, mobile telephone, radiotelephone, pager user terminal, or personal communicator, that is capable of operating with a SIM, R-UIM or the like. It should thus be clear that the present invention is not to be construed to be limited to any one particular type of terminal, communication interface standard, or communication protocol other than those that would benefit from the system and method of the present invention.

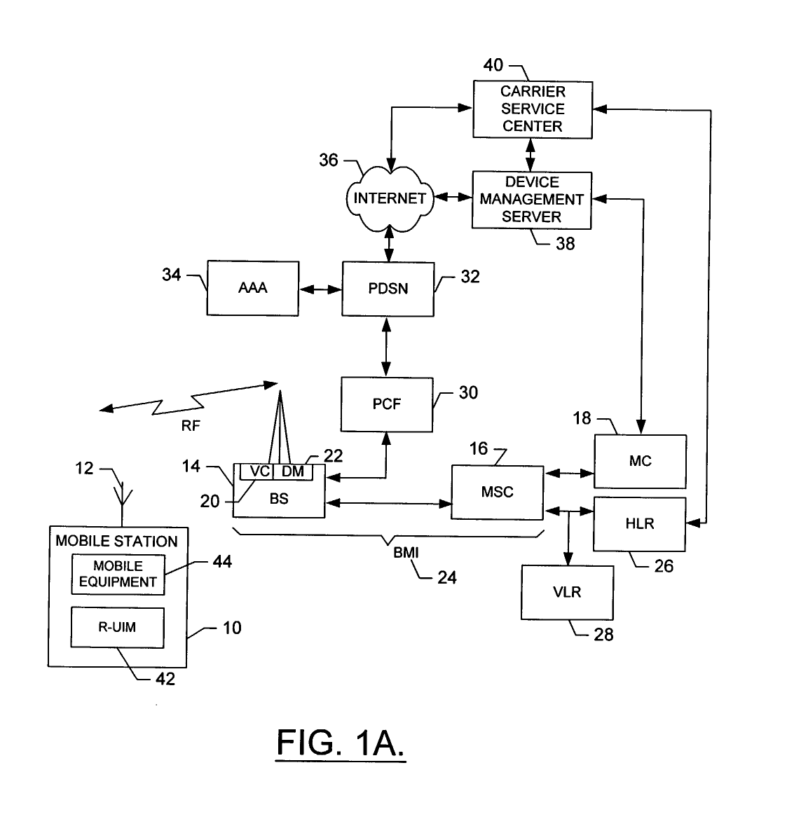

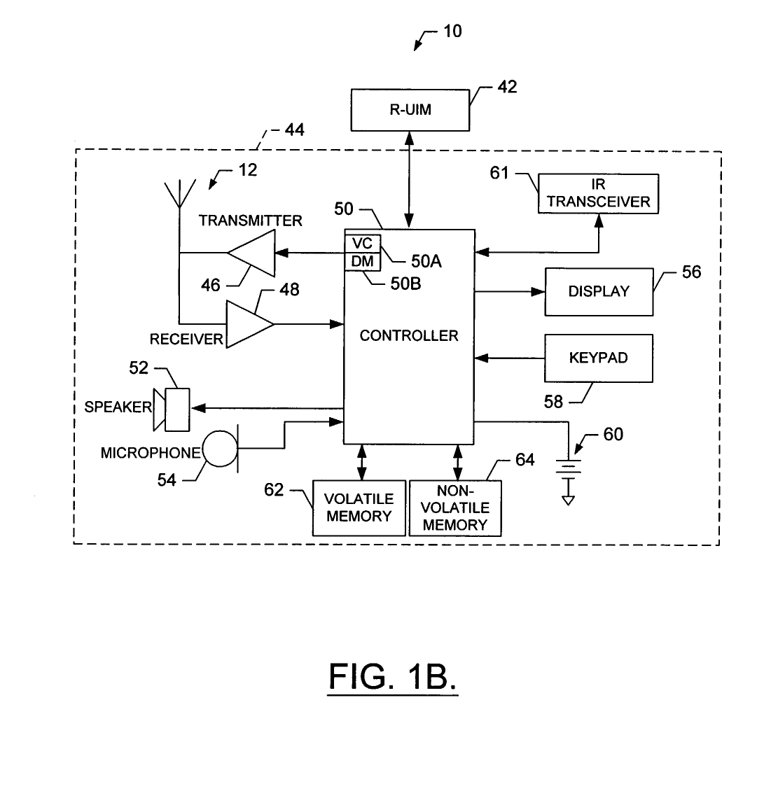

Reference is now drawn to FIG. 1A, which illustrates a wireless communications network according to various embodiments of the present invention. As shown, the mobile station 10 includes an antenna 12 for transmitting signals to and for receiving signals from a base site or base station (BS) 14. The base station is a part of a cellular network that includes a mobile switching center (MSC) 16, a message center (MC) 18, voice coder/decoders (vocoders) (VC) 20, data modems (DM) 22, and other units required to operate the network. The MSC is capable of routing calls and messages to and from the mobile station when the mobile station is making and receiving calls. As indicated above, the cellular network may also be referred to as a Base Station/MSC/Interworking function (BMI) 24. The MSC controls the forwarding of messages to and from the mobile station when the station is registered with the network, and also controls the forwarding of messages for the mobile station to and from the MC. Such messages may include, for example, voice messages received by the MSC from users of Public Switched Telephone Network (PSTN) telephones (not shown), and may also include Short Message Service (SMS) messages and voice messages received by the MSC from the mobile station or other mobile terminals (not shown) serviced by the network.

Subscriber data of a mobile station 10 is stored permanently in a Home Location Register (HLR) 26 of the system and temporarily in the Visitor Location Register (VLR) 28 in the area of which the mobile station is located at a given moment. In this regard, the VLR contains selected administrative information necessary for call control and provision of the subscribed services for each mobile station currently located in the geographical area controlled by the VLR. Although each functional entity can be implemented as an independent unit, manufacturers of switching equipment generally implement the VLR together with the MSC 16 so that the geographical area controlled by the MSC corresponds to that controlled by the VLR, thus simplifying the signaling required. As such, the MSC and VLR will collectively be referred to herein as the MSC/VLR.

The mobile station 10 can also be coupled to a data network. For example, the base station BS 14 can be connected to a packet control function (PCF) 30, which is in connection with a Packet Data Serving Node (PDSN) 32. The PDSN is preferably connected to an AAA server 34, which provides Authentication, Authorization, and Accounting services. The AAA server can comprise a Remote Access Dialup User Service (RADIUS) server, as will be appreciated by those skilled in the art. The PDSN can also be connected to a wide area network, such as the Internet 36. In turn, devices such as processing elements (e.g., personal computers, server computers or the like) can be coupled to the mobile station via the PDSN. For example, the processing elements can include a device management server 38, as well as one or more processing elements associated with a carrier service center 40, as illustrated in FIG. 1A. By directly or indirectly connecting both the mobile station and the other devices to the PDSN and the Internet, the mobile station can communicate with the other devices, such as according to the Internet Protocol (IP) specification, to thereby carry out various functions of the mobile station.

According to the present invention, most, if not all, the information elements contained in the mobile station 10 which are related to a mobile subscriber are stored and operated within a specific module, called a subscriber identity module (SIM) or, more particularly a removable user identity module (R-UIM) 42. Such information elements can include, for example, an authentication key (“A-Key”) and Number Assignment Module (NAM) parameters that control wireless network usage. The remaining part of the mobile station, called mobile equipment 44, contains the hardware and software specific to the radio interface. The R-UIM is described in more detail in Telecommunications Industry Association/Electronics Industries Association Interim Standard 820 (TIA/EIA/IS-820). The R-UIM can be a smart card, an IC card R-UIM, the interface of which with the outside world is provided in accordance with ISO standards on IC cards, i.e., ISO 7816 series. An IC card R-UIM of a standard size may be too large for hand-portable radios and, therefore, a plug-in R-UIM that is a dedicated module fully standardized within the CDMA system and intended to be semi-permanently installed in the mobile equipment can also be used.

According to the present invention, the identification of a mobile subscriber is primarily based on the information stored in the R-UIM 42. Thus, the mobile subscriber is able to use different mobile equipment 44, as long as the mobile subscriber continues to use the same R-UIM. Thus, the mobile subscriber can be reached by the same subscriber number. Without the R-UIM, only emergency calls can be made by the mobile equipment. When used in the mobile equipment, the R-UIM preferably provides storage of a number of different types of information when the R-UIM is in network operation. In this regard, the R-UIM can provide storage of subscriber-related information, such as an authentication key (“A-Key”) and Number Assignment Module (NAM) parameters that control wireless network usage, such as preferred mode of operation (analog or digital), shared secret data (SSD), and roaming information such as a “Preferred Roaming List”. Furthermore, the R-UIM storage capability may provide facilities to memorize and manage additional information elements related to the mobile subscriber in association with CDMA services and mobile station features. For more information on the information stored in the R-UIM see TIA/EIAIIS-820.

Reference is now drawn to FIG. 1B, which illustrates a block diagram of a mobile station 10 that would benefit from the present invention. The mobile station includes a transmitter 46, a receiver 48, and a controller 50 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. For example, the mobile station may be capable of operating in accordance with wireless communication protocols IS-136, GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 50 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 50A, and may include an internal data modem (DM) 50B.

The mobile station 10 also comprises a user interface including a conventional earphone or speaker 52, a conventional microphone 54, a display 56, and a user input interface, all of which are coupled to the controller 50. The user input interface, which allows the mobile station to receive data, can comprise any of a number of devices allowing the mobile station to receive data, such as a keypad 58, a touch display (not shown) or other input device. In embodiments including a keypad, the keypad includes the conventional numeric (0-9) and related keys (#, *), and other keys used for operating the mobile station. The mobile station also includes a battery 60, such as a vibrating battery pack, for powering the various circuits that are required to operate the mobile station, as well as optionally providing mechanical vibration as a detectable output, as described below.

Mobile station 10 can further include an infrared transceiver 61 or other means of data transfer so that data can be shared with other devices such as other mobile stations, car guidance systems, personal computers, printers and the like. The sharing of data, as well as the remote sharing of data, can also be provided according to a number of different techniques. For example, the mobile station may share data via a Radio Frequency Identification (RFID) transponder tag, as such is known to those skilled in the art. Additionally, or alternatively, the mobile station may share data using Bluetooth brand wireless technology developed by the Bluetooth Special Interest Group.

In addition to the R-UIM 42, the mobile station 10 can include other memory to store data upon receipt from the various sources. In this regard, the mobile station can include volatile memory 62, such as volatile Random Access Memory (RAM) including a cache area for the temporary storage of data. The mobile station can also include other non-volatile memory 64, which can be embedded and/or may be removable. The non-volatile memory can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile station to implement the functions of the mobile station. For example, the memories, and particularly the non-volatile memory, can include a directory of names and associated location identifiers, such as mobile telephone numbers, landline telephone numbers, SMS numbers, pager numbers, facsimile numbers, and/or electronic mail (E-mail) addresses that may be entered into memory and thereafter accessed by the user. The memories can also include software routines that control the operation of all or a portion of the controller 50 to thereby implement the present invention. The controller, which can include embedded cache memory, generates appropriate commands and controls the other component blocks of the mobile station.

The information stored in the mobile station 10 that can be manipulated by actions over the BMI 24 are preferably organized by the controller 50 in a hierarchical management tree, also referred to as a device management tree. In this regard, the device management tree organizes all available information in the mobile station as a hierarchical tree structure where the information can be uniquely addressed with a uniform resource identifier (URI) based upon the location of the information in the device management tree. Each addressed piece of information within the device management tree can, in turn, include a set of properties, such as an access control list (ACL), a name, a type, a version number and a time stamp. Such a device management tree is described in further detail in version 1.1 of the SyncML standard specification SyncML Management Tree and Description.

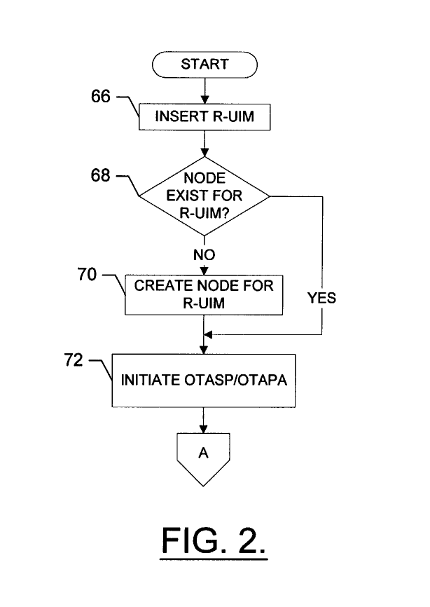

Control of the operation of the mobile station 10 typically begins with over-the-air service provisioning (OTASP) to activate the mobile station in the wireless communications network. Referring to FIG. 2, before the OTASP can begin, however, the mobile equipment 44 is preferably equipped with a R-UIM 42, such as by inserting the R-UIM into the mobile equipment, as shown in block 66. Once the R-UIM has been inserted into the mobile equipment, the controller 50 reads an identifier unique to the RUIM, referred to as a UIMID, from the R-UIM. After reading the UIMID, the controller determines whether a node in the device management tree includes the particular R-UIM, as identified by the UIMID, as shown in block 68. If a node in the device management tree does not exist for the R-UIM, the controller establishes such a node and labels the node with the UIMID, as illustrated in block 70. In the device management tree, the information stored on the R-UIM can then be organized underneath the UIMID and, thus, associated with the R-UIM in the tree.

Once a node has been established for the R-UIM 42 in the device management tree of the mobile station 10, the OTASP can be initiated, as shown in block 72 of FIG. 2. Typically, OTASP can be initiated at one of two ends of the system, either at the mobile station 10 or at the network. In this regard, the mobile station initiated method allows the mobile station user to select a wireless service carrier, to activate the mobile station and to update information stored in the mobile station, such as NAM parameters and other information stored in the R-UIM. In contrast, the network-initiated procedure, also known as Over-The-Air Parameter Administration (OTAPA), allows the wireless service carrier to update information stored in the mobile station, such as the NAM parameters and other information stored in the R-UIM. In this regard, OTAPA is also built upon the over-the-air programming protocol and methods that support OTASP.

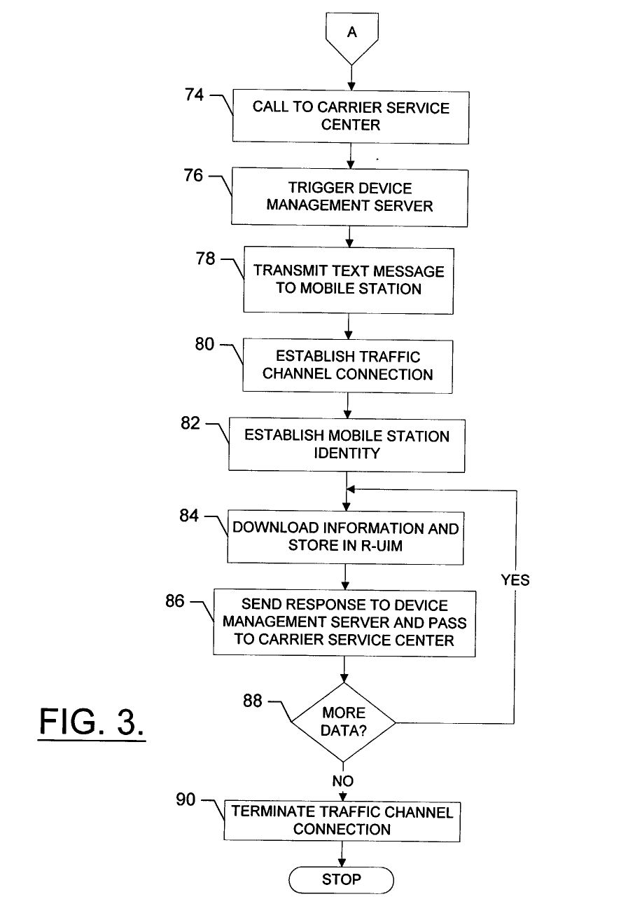

With reference to FIG. 3, user-initiated OTASP typically begins with an origination call to the carrier service center 40 of a selected wireless service carrier, as shown in block 74. The wireless service carrier can be selected in any one of a number of different ways. For example, the wireless service carrier can be selected by programming the mobile station 10 to attempt OTASP with one or more particular service carrier, or by programming the mobile station to scan for multiple service providers and thereafter presenting the user with a list from which to choose a wireless service carrier. The carrier service center is shown as being coupled to the base station BS 14 via the PDSN 32. However, it will be appreciated that the carrier service center can also be coupled to the MSCNLR via a Public Switched Telephone Network (PSTN) (not shown). In this regard, it will also be appreciated that the origination call is typically transferred to the carrier service center as a service request via the base station BS, MSC/VLR and PSTN. Further, it will be appreciated that as the subscriber data of a mobile station is stored permanently in the HLR 26, the carrier service center is also preferably connected to or otherwise associated with the HLR.

Upon receipt of the service request, the carrier service center 40 triggers the device management server 38 to begin a management session with the mobile station 10, as shown in block 76. The carrier service center can trigger the device management server according to any one of a number of different methods, as will be appreciated by those skilled in the art. In response to the trigger from the carrier service center, the device management server begins the management session by transmitting a text message, such as an SMS message, to the mobile station via the MC 18, as illustrated in block 78. The text message notifies the mobile station that the device management server is setting up a device management session. Thus, as illustrated in block 80, the mobile station establishes a connection with the device management server in response to the text message. In this regard, the mobile station preferably establishes a connection with the device management server by setting up a traffic channel between the mobile station and the device management server, such as by setting up an IP connection with the device management server over the PDSN 32.

Once the traffic channel has been established between the mobile station 10 and the device management server 38, the mobile station identifies itself to the device management server, as shown in block 82. By identifying itself, the mobile station establishes a unique identity with the device management server and gives the device management server information about the mobile station capabilities, as well as the information stored in the mobile station or, more particularly, the R-UIM 42. The mobile station can identify itself to the device management server in any one of a number of ways but, according to one embodiment, the mobile station transmits a hash function including the UIMID, an OTAPA/SPC_Enable value, and a R-UIM revision value. As will be appreciated by those skilled in the art, the OTAPA/SPC_Enable parameter establishes the authority of the device management server to perform OTAPA on the NAM and/or manipulate the service programming code (SPC) of the mobile station, and the R-UIM revision identifies the version and, thus, the capabilities of the R-UIM. For more information on the OTAPA/SPC_Enable value and the R-UIM revision value, as well as the UIMID, see the TIA/EIA/IS-820.

Upon receipt of the hash function, if the mobile station 10 has properly identified itself to the device management server 38, the device management server assigns, establishes or otherwise sets a number of parameters for the mobile station. For example, the device management server can assign a Mobile Identification Number (MIN) to the mobile station, as well as establish an authentication key (“A-Key”) and NAM parameters, including a preferred mode of operation (analog or digital), shared secret data (SSD), and roaming information such as a “Preferred Roaming List.” Either as each parameter is assigned, or after all of the parameters are assigned, each parameter is downloaded to the mobile station from the device management server over the traffic channel, as shown in block 84. Upon receipt of each parameter, the controller 50 passes the parameter to the R-UIM 42 where the parameter is stored. In this regard, the parameter is preferably stored in the R-UIM utilizing the device management tree such that the parameter is associated with a unique UIM in the device management tree. Also, an ACL associated with each parameter can be established or updated accordingly, as will be appreciated by those skilled in the art.

After successful storage of the parameter, the mobile station 10 transmits a response to the device management server 38 acknowledging a successful parameter transfer, as shown in block 86. The response can then be passed by the device management server to the carrier service center 40. After each parameter has been downloaded, the device management server determines whether to download more parameters to the mobile station, as shown in block 88. If more parameters are to be downloaded, the device management server downloads each parameter as before, with the mobile station responding as before. If no more parameters are to be downloaded, however, the device management server terminates the traffic channel connection between the device management server and the mobile station, as shown in block 90.

After OTASP, the mobile station 10 is thus registered with the wireless communications network, and thereafter operate on the network in a manner known to those skilled in the art. Subsequent to the initial OTASP, the carrier service center 40 may desire to update some of the parameters previously downloaded into the R-UIM 42. Thus, the carrier service center initiates an OTAPA session. It will be appreciated that the OTAPA session proceeds just as the OTASP session with the exception that the carrier service center initiates OTAPA. Thus, OTAPA begins with the carrier service center triggering the device management server 38 to initiate a device management session. The device management session then proceeds as before to update the parameters previously downloaded into the R-UIM.

As described above a traffic channel connection is established between the mobile station 10 and the device management server 38, and the parameters are downloaded to the mobile station 10 over the traffic channel connection. In this regard, the parameters are downloaded to the mobile station independent of the bandwidth limited signaling channel. Thus, it will be appreciated that the connection between the mobile station and the device management server can be established in a number of other manners independent of the signaling channel. For example, a data connection can be established between the mobile station and the device management server via the infrared transceiver 61 or other means of data transfer (e.g., Bluetooth brand wireless technology). In such instances, the mobile station can set up an IrDA or Bluetooth connection between the mobile station and the device management server. The method can then proceed as before with the parameters being downloaded over the IrDA or Bluetooth connection, such as according to the Object Exchange (OBEX) protocol.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of downloading at least one of a plurality of operating parameters to a mobile station that operates within a network, the plurality of operating parameters being stored within a removable user identity module (R-UIM), the method comprising:
transmitting a text message to the mobile station over the network;
receiving the text message and thereafter establishing a traffic channel connection between the mobile station and a device management server;
establishing an identity of the mobile station with the device management server;
downloading operating parameters from the device management server to the mobile station via the traffic channel; and
storing the operating parameters in the R-UIM.

2. A method according to claim 1 further comprising terminating the traffic channel connection between the mobile station and the device management server after downloading the operating parameters.

3. A method according to claim 1, wherein the mobile station comprises mobile equipment and the R-UIM, wherein the method further comprises:
inserting the R-UIM into the mobile equipment; and
establishing a node for the R-UIM in a hierarchical device management tree of the mobile station,
wherein inserting the R-UIM and establishing a node occur before transmitting a text message, and wherein storing the operating parameters comprises storing the operating parameters in the R-UIM based upon the node established for the R-UIM.

4. A method according to claim 1, wherein the mobile station operates within a cellular network and a data network, wherein transmitting and receiving a text message occur over the cellular network, and wherein establishing an identity and downloading operating parameters occur over the data network.

5. A method according to claim 1, wherein establishing an identity comprises transmitting a hash function to the device management server, and wherein the hash function identifies the R-UIM and establishes authority for downloading the operating parameters.

6. A method according to claim 1, wherein the mobile station includes a hierarchical device management tree having a node for the R-UIM, and wherein storing the operating parameters comprises storing the operating parameters in the R-UIM based upon the node for the R-UIM in the device management tree.

7. A method according to claim 1, wherein establishing a traffic channel connection comprises establishing an Internet Protocol (IP) connection between the mobile station and a device management server, and wherein downloading operating parameters comprises downloading the operating parameters via the IP connection.

8. A wireless communications network comprising:
at least one mobile station, each mobile station having a plurality of operating parameters stored within a removable user identity module (R-UIM), at least one of the plurality of operating parameters capable of being downloaded to the mobile station; and
a device management server capable of controlling a message center to transmit a text message to said at least one mobile station over the network such that said at least one mobile station establishes a traffic channel connection between the mobile station and said device management server in response to the text message,
wherein said at least one mobile station is capable of establishing an identity of the mobile station with said device management server such that said device management server can download operating parameters to the mobile station via the traffic channel, and wherein said at least one mobile station is capable of storing the operating parameters in the R-UIM.

9. A wireless communications network according to claim 8, wherein said device management server is further capable of terminating the traffic channel connection between the mobile station and the device management server after downloading the operating parameters.

10. A wireless communications network according to claim 8, wherein each mobile station comprises mobile equipment and the R-UIM, wherein the mobile equipment of each mobile station is capable of establishing a node for the R-UIM in a hierarchical device management tree of the respective mobile station, and wherein each mobile station is capable of storing the operating parameters in the R-UIM based upon the node for the R-UIM in the device management tree.

11. A wireless communications network according to claim 8, wherein the wireless communications network includes a cellular network and a data network, wherein each mobile station is included in each of the cellular network and the data network, wherein said device management server is included within the data network, wherein said device management server is capable of controlling the message center to transmit a text message to said at least one mobile station over the cellular network, wherein said at least one mobile station is capable of establishing an identity of the mobile station with the device management server over the data network, and wherein said device management server is capable of downloading the operating parameters to the mobile station over the data network.

12. A wireless communications network according to claim 8, wherein said at least one mobile station is capable of establishing an identity by transmitting a hash function to the device management server, and wherein the hash function identifies the R-UIM and establishes authority for downloading the operating parameters.

13. A wireless communications network according to claim 8, wherein the mobile station includes a hierarchical device management tree having a node for the R-UIM, and wherein said mobile station is capable of storing the operating parameters in the R-UIM based upon the node for the R-UIM in the device management tree.

14. A wireless communications network according to claim 8, wherein the traffic channel established by said at least one mobile station comprises an Internet Protocol (IP) connection between said at least one mobile station and said device management server, and wherein said device management server is capable of downloading the operating parameters via the IP connection.

15. A mobile station adapted to communicate via a wireless communications network, said mobile station comprising:
a removable user identity module (R-UIM), wherein said R-UIM is capable of storing a plurality of operating parameters stored within a removable user identity module (R-UIM), at least one of the plurality of operating parameters capable of being downloaded to the mobile station; and
mobile equipment capable of controlling operation of the mobile station, wherein said mobile equipment is capable of receiving a text message and thereafter establishing a traffic channel connection between the mobile station and the device management server, wherein said mobile equipment is also capable of establishing an identity of the mobile station with the device management server such that the device management server can download operating parameters to the mobile station via the traffic channel, wherein said mobile equipment is capable of receiving the downloaded operating parameters and thereafter storing the operating parameters in the R-UIM.

16. A mobile station according to claim 15, wherein said mobile equipment is further capable of receiving the R-UIM into the mobile equipment, wherein said mobile equipment is capable of establishing a node for the R-UIM in a hierarchical device management tree of the mobile station, and wherein said mobile equipment is capable of storing the operating parameters in the R-UIM based upon the node established for the R-UIM.

17. A mobile station according to claim 15, wherein the mobile station operates within a cellular network and a data network, wherein said mobile equipment is capable of receiving the text message over the cellular network, wherein said mobile equipment is capable of establishing the identity over the data network, and wherein said mobile equipment is capable of receiving the downloaded operating parameters over the data network.

18. A mobile station according to claim 15, wherein said mobile equipment is capable of establishing the identity by transmitting a hash function to the device management server, and wherein the hash function identifies the R-UIM and establishes authority for downloading the operating parameters.

19. A mobile station according to claim 15, wherein said mobile equipment includes a hierarchical device management tree having a node for the R-UIM, and wherein said mobile equipment is capable of storing the operating parameters in the RUIM based upon the node for the R-UIM in the device management tree.

20. A mobile station according to claim 15, wherein the traffic channel connection established by said mobile equipment comprises an Internet Protocol (IP) connection, wherein said mobile equipment is capable of establishing the identity such that the device management server can download operating parameters to the mobile station via the IP connection, and wherein said mobile equipment is capable of receiving the downloaded operating parameters via the IP connection.

21. A method of downloading at least one of a plurality of operating parameters to a mobile station that operates within a network, the plurality of operating parameters being stored within a removable user identity module (R-UIM), the method comprising:
transmitting a text message to the mobile station over the network;
receiving the text message and thereafter establishing a data connection between the mobile station and a device management server independent of a signaling channel;
establishing an identity of the mobile station with the device management server;
downloading operating parameters from the device management server to the mobile station via the data channel; and storing the operating parameters in the R-UIM.

22. A method according to claim 19, wherein establishing a data connection comprises establishing a traffic channel connection between the mobile station and the device management server, and wherein downloading operating parameters comprises downloading operating parameters via the traffic channel connection.

23. A method according to claim 21, wherein establishing a data connection comprises establishing a Bluetooth connection between the mobile station and the device management server, and wherein downloading operating parameters comprises downloading operating parameters via the Bluetooth connection.

24. A method according to claim 21, wherein establishing a data connection comprises establishing an infrared connection between the mobile station and the device management server, and wherein downloading operating parameters comprises downloading operating parameters via the infrared connection.

25. A method according to claim 21, wherein the mobile station comprises mobile equipment and the R-UIM, wherein the method further comprises:
inserting the R-UIM into the mobile equipment; and
establishing a node for the R-UIM in a hierarchical device management tree of the mobile station,
wherein inserting the R-UIM and establishing a node occur before transmitting a text message, and wherein storing the operating parameters comprises storing the operating parameters in the R-UIM based upon the node established for the R-UIM.
